(19) United States
(12) Patent Application Publication
(10) Pub. No.: US 2022/0148403 A1
(43) Pub. Date: May 12, 2022

(54) SMOKE DETECTOR SENSITIVITY FOR BUILDING HEALTH MONITORING

(71) Applicant: Carrier Corporation, Palm Beach Gardens, FL (US)

(72) Inventors: Slade R. Culp, Coventry, CT (US); Peter R. Harris, Jupiter, FL (US); Jennifer Alexander, Glastonbury, CT (US); Rajiv Ranjan, East Syracuse, CT (US)

(21) Appl. No.: 17/453,019

(22) Filed: Nov. 1, 2021

Related U.S. Application Data
(60) Provisional application No. 63/198,725, filed on Nov. 9, 2020.

(51) Int. Cl. G08B 17/10; G08B 21/18; G08B 27/00; F24F 11/33; F24F 11/58; H04L 67/125

(52) U.S. Cl. CPC G08B 17/10; G08B 21/182; H04L 67/125; F24F 11/33; F24F 11/58; G08B 27/005

(57) ABSTRACT

A detection system including a smoke detector configured to transmit a detector baseline signal to at least one of a control panel and a server (e.g., to establish at least one indoor air quality trend), and a method for monitoring indoor air quality with at least one smoke detector are provided. The smoke detector includes a processor configured determine whether a current condition indicates a need to trigger an alarm. The smoke detector is configured to measure a baseline. The detector baseline signal is used (e.g., by the control panel and/or the server) to establish at least one indoor air quality (IAQ) trend.

### CROSS REFERENCE TO A RELATED APPLICATION

The application claims the benefit of U.S. Provisional Application No. 63/198,725 filed Nov. 9, 2020, the contents of which are hereby incorporated in their entirety.

### BACKGROUND

A smoke detector is a device that detects smoke and issues an alarm. A photo-electric smoke detector is a type of smoke detector that works based on light scattering principles. An ionization smoke detector is a type of smoke detector that works by monitoring the flow of ionic current through the smoke detector. Both the ionization-type and the photoelectric-type smoke detectors can be sensitive to dust and dirt accumulation in their detection chambers. In ionization-type smoke detectors, the presence of dust particles decreases conductivity and thereby distorts the ionic current flow. In photoelectric-type smoke detectors, the dust particles that accumulate on the detection chamber walls scatter light onto the light sensor and thereby cause false alarms and increase background noise.

Because the presence of dust in smoke detectors cannot be readily avoided, most commercial fire codes mandate that regular testing and cleaning procedures be instituted to avoid excessive dust accumulation. Unfortunately, cleaning a detector can be expensive, inconvenient, and time-consuming. Previously, some smoke detectors have been designed to minimize the amount of dust that settles on the walls of the detection chamber. However, the cost and complexity of such smoke detectors is relatively high. Therefore, many smoke detectors today include drift compensation to account for the change in the clean air signal (detector baseline drift), which, as mentioned above, may increase (for photoelectric-type detectors) or decrease (for ionization-type detectors) as a result of dust accumulation.

Drift compensation methodologies can provide for changing the alarm threshold that must be crossed for an alarm to be triggered (e.g., so as to be able to consistently, accurately detect the presence of smoke as dust accumulates). The rate that the smoke detector gets dirty (and therefore the rate at which drift compensation needs to be employed) may be dependent on the environment in which the smoke detector is configured. For example, drift compensation may need to be employed more rapidly in dirtier environments than cleaner environments. This drift compensation may be completed either locally within the detector, or remotely at a control panel (which may be connected to multiple detectors). It is generally understood that the compensation may only be able to be adjusted to a certain point (which may be referred to as a drift compensation limit). As such, it is recommended that the detector be cleaned or replaced before the drift compensation limit is reached.

With increasing interest and awareness of indoor air quality (IAQ) it is vitally important that we utilize any readily available data regarding IAQ. As such, it is imperative that we recognize that existing smoke detection systems do not utilize the detector baseline drift data outside of adjusting the smoke detectors (i.e. to ensure that the smoke detectors are able to consistently, accurately detect the presence of smoke as dust accumulates).

Accordingly, there remains a need for a system and a method that are capable of utilizing the detector baseline drift data in a meaningful way so as to provide better, more robust monitoring of indoor air quality.

### BRIEF DESCRIPTION

According to one embodiment, a detection system including a smoke detector and at least one of a control panel and a server is provided. The smoke detector including processor configured to determine whether a current condition indicates a need to trigger an alarm. The smoke detector configured to measure a baseline. At least one of a control panel and a server configured to receive and compile detector baseline signal to establish at least one indoor air quality (IAQ) trend.

In accordance with additional or alternative embodiments, each detector is configured to compensate for detector baseline drift.

In accordance with additional or alternative embodiments, the control panel is configured to receive detector baseline signals from multiple smoke detectors.

In accordance with additional or alternative embodiments, each respective smoke detector is configured to detect ambient materials within a room of a building, each building including at least one control panel.

In accordance with additional or alternative embodiments, the server is communicatively connected to at least one control panel.

In accordance with additional or alternative embodiments, at least one of the control panel and the server are configured to trigger a notification when an IAQ trend meets a certain criteria.

In accordance with additional or alternative embodiments, at least one of the control panel and the server are operably connected to an HVAC system, at least one of the control panel and the server configured to execute one or more HVAC system controls in response to at least one indoor air quality (IAQ) trend.

In accordance with additional or alternative embodiments, the detection system further includes a mobile device communicatively connected to at least one of the control panel and the server.

In accordance with additional or alternative embodiments, the mobile device includes an application, at least one indoor air quality (IAQ) trend viewable in the application.

In accordance with additional or alternative embodiments, the mobile device includes at least one of a mobile phone, a mobile tablet, and a computer.

According to another aspect of the disclosure, a method for monitoring indoor air quality with at least one smoke detector is provided. Each respective smoke detector including a processor configured to determine whether a current condition indicates a need to trigger an alarm. Each respective smoke detector is configured to measure a baseline. The method includes a step for transmitting at least one detector baseline signal from at least one smoke detector to at least one of a control panel and a server. The method includes a step for compiling, in at least one of the control panel and the server, the detector baseline signals to establish at least one indoor air quality (IAQ) trend.

In accordance with additional or alternative embodiments, each detector is configured to compensate for detector baseline drift.

In accordance with additional or alternative embodiments, the control panel is configured to receive detector baseline signals from multiple smoke detectors.

In accordance with additional or alternative embodiments, the method further includes a step for triggering, with at least one of the control panel and the server, a notification when an IAQ trend meets a certain criteria.

In accordance with additional or alternative embodiments, the method further includes a step for executing, with at least one of the control panel and the server, one or more HVAC system controls of an HVAC system in response to an IAQ trend.

In accordance with additional or alternative embodiments, a mobile device is communicatively connected to at least one of the control panel and the server.

In accordance with additional or alternative embodiments, the mobile device includes an application, at least one indoor air quality (IAQ) trend viewable in the application.

In accordance with additional or alternative embodiments, the mobile device includes at least one of a mobile phone, a mobile tablet, and a computer.

### BRIEF DESCRIPTION OF THE DRAWINGS

The subject matter, which is regarded as the disclosure, is particularly pointed out and distinctly claimed in the claims at the conclusion of the specification. The following descriptions of the drawings should not be considered limiting in any way. With reference to the accompanying drawings, like elements are numbered alike:

FIG. 1 is a schematic illustration of an exemplary detection system including multiple smoke detectors configured to transmit detector baseline signals to at least one of a mobile device, a control panel, and a server, in accordance with one aspect of the disclosure.

FIG. 2 is an exploded view of an exemplary smoke detector in accordance with one aspect of the disclosure.

FIG. 3 is an illustration of an exemplary mobile device displaying an exemplary indoor air quality (IAQ) trend for a floor of a building in accordance with one aspect of the disclosure.

FIG. 4 is an illustration of an exemplary mobile device displaying an exemplary indoor air quality (IAQ) trend for a particular room of the building shown in FIG. 4 in accordance with one aspect of the disclosure.

FIG. 5 is an illustration of an exemplary mobile device displaying an exemplary indoor air quality (IAQ) trend for a particular detector within the particular room shown in FIG. 5 in accordance with one aspect of the disclosure.

FIG. 6 is a flow diagram illustrating a method for monitoring indoor air quality (IAQ) with at least one smoke detector in accordance with one aspect of the disclosure.

### DETAILED DESCRIPTION

A detection system including a smoke detector configured to transmit a detector baseline signal (which may also be called a clean air signal) to at least one of a control panel and a server (in order to establish at least one indoor air quality (IAQ) trend), and a method for monitoring general indoor air quality trends with at least one smoke detector are provided. Rather than only using the detector baseline drift data to employ drift compensation to the smoke detector (i.e. to ensure that the smoke detector is able to consistently and accurately detect the presence of smoke as dust accumulates), the detection system described herein further utilizes the detector baseline data to provide insightful IAQ trends. It should be appreciated that these IAQ trends are capable of being provided without necessitating additional hardware (i.e. no independent IAQ specific detectors are required to produce the IAQ trends illustrated herein). By utilizing existing smoke detectors and existing detector baseline drift data, the cost and complexity of installing the detection system may be minimal (e.g., when compared to existing air quality monitoring systems that require dedicated, independent pieces of hardware). It is envisioned that these IAQ trends may be useful to estimate building health in comparison with historic trends or other buildings, which may empower building management systems to take action to improve building health. These IAQ trends may be provided in a wholistic manner (i.e. provided in the form of one IAQ trend for an entire building) and/or granular manner (i.e. provided in the form of one IAQ trend for a particular room, or even one IAQ trend for a particular smoke detector) in certain instances. For example, the IAQ trend(s) may provide room-to-room insights, or even building-to-building insights, which may be useful in situations such as university campuses, where multiple buildings are maintained by one entity. Although described herein to be particularly useful in commercial buildings and universities, it should be appreciated that the detection system described herein may be useful in any setting (e.g. residential, etc.).

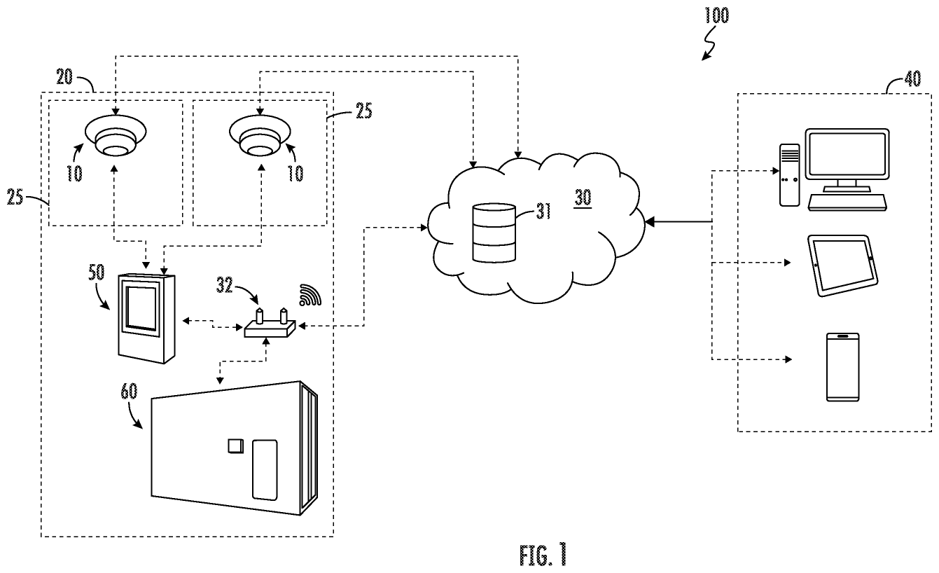

With reference now to the Figures, a schematic illustration of an exemplary detection system 100 including multiple smoke detectors 10 configured to transmit detector baseline signals to at least one of a control panel 50 and a server 31 is shown in FIG. 1. The smoke detector(s) 10 may, in certain instances, be referred to as a “detector(s)”. It should be appreciated that although described herein as being used to detect smoke, the detector(s) 10, may, in certain instances, also be used to detect other constituents capable of entering the detector 10 (e.g. carbon monoxide, or other hazardous or nuisance materials). The smoke detector 10 may be capable of detecting when ambient materials, such as smoke and non-smoke particles carried in the air, enter the smoke detector 10. It should be appreciated that the smoke detector(s) may use any suitable smoke detection technology, which may be either ionization or photoelectric based in certain instances.

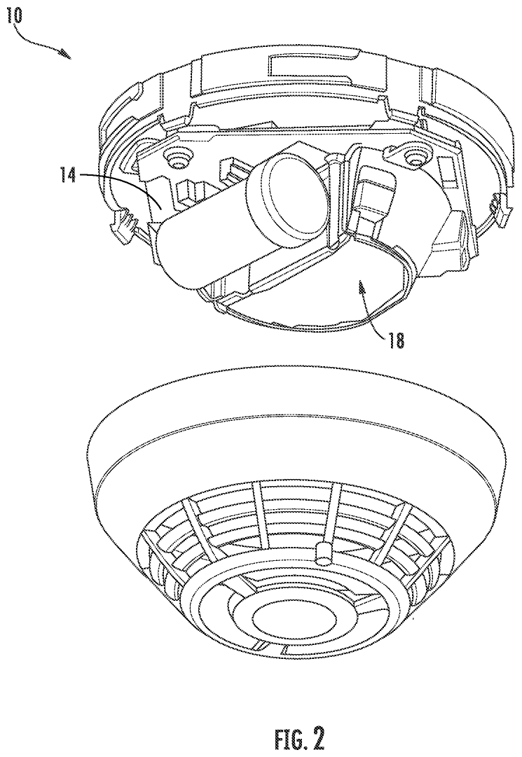

An exemplary smoke detector 10 is shown in FIG. 2. This smoke detector 10 is capable of detecting smoke using a photoelectric detection method. As shown, the smoke detector 10 may include a chamber 18 for receiving ambient airborne materials, and a supporting structure 14 (e.g., a PCB) disposed adjacent to the chamber 18. It should be appreciated that the smoke detector 10 may also include at least one optical component (not shown). For example, the smoke detector 10 may include one or more emitter(s) and/or receiver(s), which may be considered optical components. The emitter(s) may be any suitable light emitting diode (LED) capable of emitting light (e.g. infrared or any light in the visible spectrum, such as blue light) into the chamber 18. The receiver(s) may be configured to receive light reflected from the ambient materials in the chamber 18 and generate output signals (i.e. indicative of the current condition of the chamber 18). The output signals may be sent from the receiver to the processor (which may be disposed on the supporting structure 14 as a component of the supporting structure 14) to determine whether a current condition of the chamber 18 indicates a need to employ compensation drift or trigger a fault or an alarm. Although described herein that the smoke detector 10 may include a chamber 18 in certain instances, it should be appreciated that the smoke detector 10 may be chamberless (i.e., emit light into a monitored space instead of a chamber 18) in other instances.

When there is no smoke in the air, light emitted from the detector LEDs scatter off of the interior surface of the chamber and are received by the photodiode(s). This received signal in clean air (no smoke) is referred to here as the detector baseline. Over time, dust/dirt in the air can accumulate on the interior surface of the chamber 18. This causes the interior surfaces to scatter more light from the LEDs and increase the detector baseline (referred to as detector baseline drift). To compensate for detector baseline drift, the smoke detector 10 is configured to measure the detector baseline (and adjust the baseline if necessary). It should be appreciated that the detection system 100 described herein may incorporate multiple smoke detectors 10, each of which may be capable of measuring (and, if necessary, adjusting) their baseline to compensate for detector baseline drift. In certain instances the smoke detector 10 is configured to generate a fault when the smoke detector 10 reaches a certain level of dirtiness (the detector baseline exceeds a threshold). It is envisioned that the rate at which this detector baseline drift occurs may correlate to the indoor air quality (IAQ) of the environment in which the smoke detector 10 is placed (i.e. the drift rate may be faster in environments with more dust/dirt in the air).

As shown in FIG. 1, each smoke detector 10 may be configured to transmit a detector baseline signal to at least one of a control panel 50 and a server 31 (e.g., which may be housed in a cloud-based network 30). It should be appreciated that the transmission may not be direct in certain instances. For example, the detector baseline signal may be transmitted to the control panel 50 from the smoke detector 10 before the detector baseline signal is transmitted to the server 31 or to a mobile device 40. It is envisioned that the control panel 50 may be configured to receive detector baseline signals from multiple smoke detectors 10. For example, as shown in FIG. 1, each respective smoke detector 10 may be configured to detect ambient materials within a particular room 25 of a building 20, which may include at least one control panel 50. It should be appreciated that each control panel 50 may be connected to numerous hazard detectors (e.g. smoke detectors 10, etc.), notification devices (e.g. horns, strobes, annunciators, etc.), alarm triggers (e.g. pull stations, call points, door alarms, etc.), and other communicatively connected infrastructure. To receive the detector baseline signals from the respective smoke detector(s) 10, the control panel 50 may be connected through one or more physical link(s) (e.g., hard-wired), and/or wireless connection(s) (e.g. using Wi-Fi, Bluetooth, Bluetooth Low Energy (BTLE), Zigbee, infrared, cellular, or any other suitable wireless connection) to one or more smoke detectors 10.

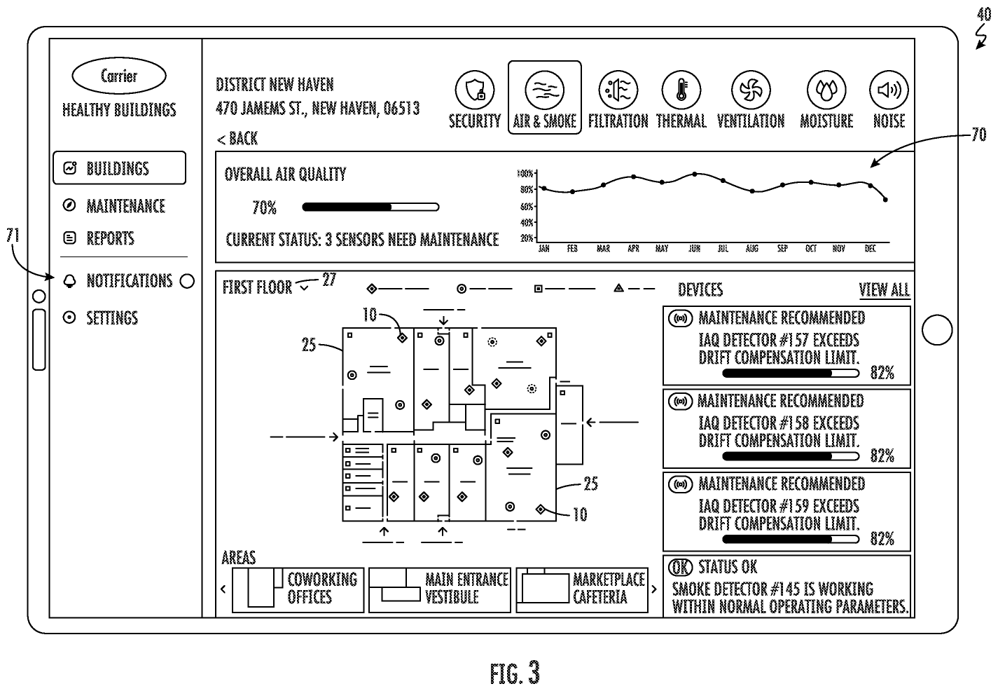

As shown in FIG. 1, the control panel 50 may be communicatively connected to the server 31 using at least one gateway 32, such as a router (which may be located within same building 20 in which the control panel 50 is located). The connection between the control panel 50 and the gateway 32 may be completed through any suitable wireless connection(s) (e.g., Wi-Fi, Bluetooth, Bluetooth Low Energy (BTLE), Zigbee, infrared, cellular, or any other suitable wireless connection), and/or a wired connection(s) (e.g. UART, Serial, Fiber-optic, SPI, Ethernet cable, or any other suitable wired connection). It is envisioned that the compiling of the detector baseline signals to establish at least one indoor air quality (IAQ) trend 70 (shown in FIGS. 3-5) may be completed in at least one of the control panel 50 and the server 31 (e.g., using any suitable processor, programming, etc.). In certain instances a mobile device 40 is communicatively connected (e.g., through one or more wired or wireless connections) with at least one of the control panel 50 and the server 31.

For example, it is envisioned that the server 31 may be an application server in certain instances, and one or more mobile device(s) 40 may be seamlessly connected with the server 31 though an application, which may be either web-based or downloaded to the memory of the mobile device 40) so as to enable interaction (e.g., to view the IAQ trends, etc.) with the detection system 100. The mobile device(s) 40 described herein may include, among others, mobile phones, mobile tablet, or computers such as those running the Android™ operating system of Google Inc., of Mountain View, Calif., or the iOS™ operating system of Apple Inc., of Cupertino, Calif., or the BlackBerry™ operating system of BlackBerry Limited, of Waterloo, Ontario. The mobile device 40 may be programmed with an application (i.e. an app) that allows the mobile device 40 to interact (e.g., to view at least one IAQ trend, etc.). Exemplary mobile devices 40 displaying exemplary indoor air quality (IAQ) trends 70 are shown in FIG. 3-5.

FIG. 3 illustrates an exemplary view of an indoor air quality (IAQ) trend 70 for a floor 27 of a building 20, which, as shown, may be viewable in an application on a mobile device 40. It should be appreciated that multiple IAQ trends 70 may be provided by the detection system 100 described herein, each of which may have different levels of granularity. As shown, the IAQ trend 70 may be represented in terms of a percentage (%) which relates the adjusted baseline to the dirtiness level threshold. This percentage may indicate the level of dirtiness of the smoke detector(s) 10 on the particular floor 27. As shown, the detection system 100 may provide a notification 71 when the level of dirtiness for a particular smoke detector 10 on the particular floor 27 is above a certain level of dirtiness (such as 80%, etc.). It should be appreciated that the level of dirtiness at which a notification may triggered may vary, and, in certain instances, may be adjustable based on user preference, etc. It is envisioned that these notifications may help inform building management when a particular detector 10 is in need of cleaning or replacement. In addition to aiding with maintenance, the detection system 100 described herein may provide useful insights into long term (or short term in certain instances) indoor air quality trends for different areas (e.g., particular floors 27, etc.) of the building 20, which may encourage potential mitigation (e.g., using the HVAC system 60 (shown in FIG. 1)) of the different areas (e.g., particular floors 27, etc.).

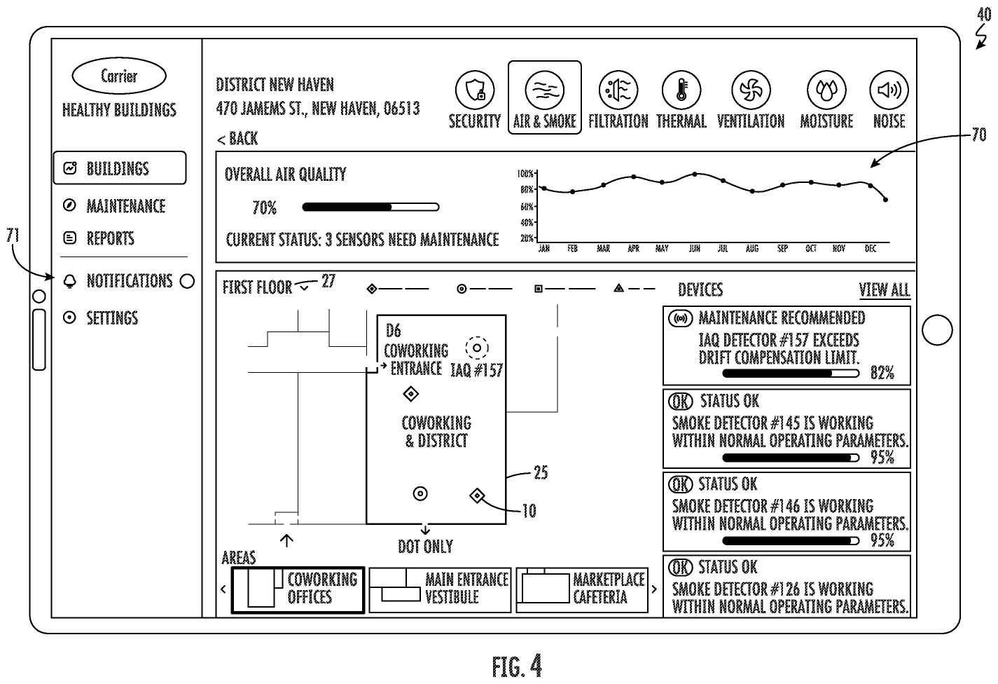

FIG. 4 illustrates an exemplary view of an indoor air quality (IAQ) trend 70 for a particular room 25 of a certain floor 27 of a building 20, which, as shown, may be viewable in an application on a mobile device 40. As shown, the detection system 100 may provide an IAQ trend 70 in terms of a particular room 25 (which may be represented in terms of a percentage (%). This percentage may indicate the level of dirtiness of the smoke detector(s) 10 in the particular room 25. As shown, the detection system 100 may provide a notification 71 when the level of dirtiness of a particular smoke detector 10 in the particular room 25 is above a certain level of dirtiness (such as 80%, etc.). It should be appreciated, as stated above, that the level of dirtiness at which a notification may be triggered may vary, and, in certain instances, may be adjustable based on user preference, etc. As described above, these notifications may help inform building management when a particular detector 10 is in need of cleaning or replacement, and may be used to illustrate mitigation needs for a particular area (e.g., floor 27, room 25, etc.).

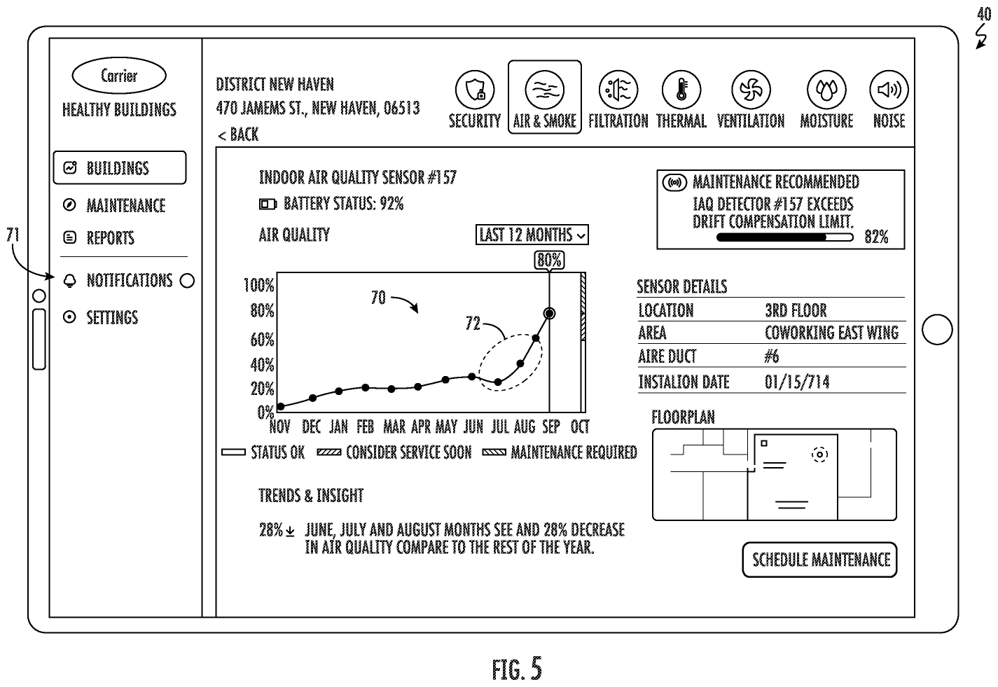

FIG. 5 illustrates an exemplary view of an indoor air quality (IAQ) trend 70 for a particular detector 10 of a building 20, which, as shown, may be viewable in an application on a mobile device 40. As shown, the detection system 100 may provide an IAQ trend 70 in terms of a particular detector 10 (e.g., which may be represented in terms of a percentage (%). This percentage may indicate the level of dirtiness of the particular detector 10. As shown, the detection system 100 may provide a notification 71 when the level of dirtiness for a particular smoke detector 10 is above a certain limit (such as 80%, etc.). It should be appreciated, as stated above, that the level of dirtiness at which a notification may be triggered may vary, and, in certain instances, may be adjustable based on user preference, etc. As described above, these notifications may help inform building management when the detector 10 is in need of cleaning or replacement, and may be used to illustrate mitigation needs for a particular area (e.g., floor 27, room 25, etc.) in which the detector 10 is placed.

At least one of the control panel 50 and the server 31 may be configured to trigger a notification 71 when an IAQ trend 70 (e.g., for a particular floor 27, room 25, detector 10, etc.) meets a certain criteria (e.g., such as an abnormality 72, etc.). An abnormality 72 may be viewed as a certain slope of the IAQ trend 70 (which may indicate a rapid change in the indoor air quality). It will be appreciated that a notification 71 may be triggered in the absence of an abnormality 72 in certain instances. For example, a notification 71 may be triggered periodically to routinely inform building management as to the IAQ trend(s) 70 even when there is no abnormality 72. These IAQ trends 70 may be useful to provide long-term (e.g., by the day, month, year, etc.) insights. As mentioned above, these trends may be useful to compare indoor air quality in a building-to-building or a room-to-room manner, which may assist with informing maintenance decisions and/or encouraging mitigation efforts (e.g., which may improve the health of those occupying the particular space).

These mitigation efforts may be in the form of executing one or more controls of an HVAC system 60 (shown in FIG. 1), which may include operating one or more different components (e.g., such as fans, vents, filtration technologies, etc.) of the HVAC system 60. To operate these components of the HVAC system 60, the HVAC system 60 may be connected to the server 31 (e.g., indirectly through connection with the gateway 32), which may enable the HVAC system 60 to be controlled in response to at least one indoor air quality trend 70. For example, the detection system 100 described herein may provide for the automatic more frequent opening of an outdoor vent and the activating of a fan to drive the air, containing the high levels of particles such as dust, etc., out of a building 20 that has been identified by the detection system 100 to have poor IAQ. These mitigation efforts, in whatever form, may help improve the health of those occupying the particular space, for example, by reducing their exposure to air with high levels of particles such as dust, dirt, etc.

As mentioned above, it is envisioned that the design and configuration of the detection system 100 described herein may make it possible to provide insightful indoor air quality trends with minimal cost and complexity (e.g., when compared to existing air quality monitoring systems that utilize dedicated, independent pieces of hardware). Instead of requiring new hardware, as is typical with air quality monitoring systems, the detection system 100 described herein utilizes readily available detector baseline data to provide insightful IAQ trends. These trends may be useful to estimate building health in comparison with historic trends, which may empower building management to take action to improve building health. It should be appreciated that the detection system 100 described herein may be useful in any environment (e.g., hospitals, restaurants, hotels, universities, etc.) that incorporates smoke detectors 10 which are capable of measuring (and, if necessary, adjusting) their baseline.

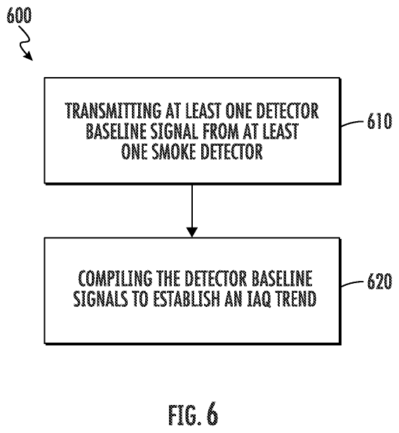

Regardless of the setting in which the detection system 100 is utilized, the method for monitoring indoor air quality may be the same. An exemplary method 600 for monitoring indoor air quality with at least one smoke detector 10 is shown in FIG. 6. The method 600 may be performed, for example, using the exemplary detection system 100 shown in FIG. 1, and described above, which may include at least one exemplary smoke detector shown in FIG. 2. The method 600 includes step 610 for transmitting a detector baseline signal from at least one smoke detector 10 to at least one of a control panel 50 and a server 31, each of which may have different limitations as set forth above. The method 600 includes step 620 for compiling, in at least one of the control panel 50 and the server 31, the detector baseline signals over time to establish at least one indoor air quality (IAQ) trend 70. In some embodiments, the smoke detector(s) 10 is configured to compensate for detector baseline drift. These IAQ trends may incorporate detector baseline signals from multiple detectors 10, each of which may be connected to the same or different control panel 50. As mentioned above, the method 600 may provide for the triggering of a notification 71 and/or the operation of one or more components of an HVAC system 60 in response to an IAQ trend. As shown in FIGS. 3-5, these IAQ trends may be provided in different levels of granularity, which may be viewable through a mobile device 40 (i.e. in an application).

The use of the terms “a” and “and” and “the” and similar referents, in the context of describing the invention, are to be construed to cover both the singular and the plural, unless otherwise indicated herein or cleared contradicted by context. The use of any and all examples, or exemplary language (e.g., “such as”, “e.g.”, “for example”, etc.) provided herein is intended merely to better illuminate the invention and does not pose a limitation on the scope of the invention unless otherwise claimed. No language in the specification should be construed as indicating any non-claimed elements as essential to the practice of the invention.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A detection system comprising:
a smoke detector comprising processor configured to determine whether a current condition indicates a need to trigger an alarm, wherein the smoke detector is configured to measure a baseline; and
at least one of a control panel and a server, at least one of the control panel and the server configured to receive and compile detector baseline signal to establish at least one indoor air quality (IAQ) trend.

2. The detection system of claim 1, wherein each detector is configured to compensate for detector baseline drift.

3. The detection system of claim 1, wherein the control panel is configured to receive detector baseline signals from multiple smoke detectors.

4. The detection system of claim 3, wherein each respective smoke detector is configured to detect ambient materials within a room of a building, each building comprising at least one control panel.

5. The detection system of claim 4, wherein the server is communicatively connected to at least one control panel.

6. The detection system of claim 1, wherein at least one of the control panel and the server are configured to trigger a notification when an IAQ trend meets a certain criteria.

7. The detection system of claim 1 wherein at least one of the control panel and the server are operably connected to an HVAC system, at least one of the control panel and the server configured to execute one or more HVAC system controls in response to at least one indoor air quality (IAQ) trend.

8. The detection system of claim 1, further comprising a mobile device communicatively connected to at least one of the control panel and the server.

9. The detection system of claim 8, wherein the mobile device comprises an application, at least one indoor air quality (IAQ) trend viewable in the application.

10. The detection system of claim 8, wherein the mobile device comprises at least one of a mobile phone, a mobile tablet, and a computer.

11. A method for monitoring indoor air quality with at least one smoke detector, each respective smoke detector comprising a processor configured to determine whether a current condition indicates a need to trigger an alarm, wherein each respective smoke detector is configured to measure a baseline, the method comprising:
transmitting at least one detector baseline signal from at least one smoke detector to at least one of a control panel and a server; and
compiling, in at least one of the control panel and the server, the detector baseline signals to establish at least one indoor air quality (IAQ) trend.

12. The method of claim 11, wherein each detector is configured to compensate for detector baseline drift.

13. The method of claim 11, wherein the control panel is configured to receive detector baseline signals from multiple smoke detectors.

14. The method of claim 11, further comprising triggering, with at least one of the control panel and the server, a notification when an IAQ trend meets a certain criteria.

15. The method of claim 14, further comprising executing, with at least one of the control panel and the server, one or more HVAC system controls of an HVAC system in response to an IAQ trend.

16. The method of claim 11, wherein a mobile device is communicatively connected to at least one of the control panel and the server.

17. The method of claim 16, wherein the mobile device comprises an application, at least one indoor air quality (IAQ) trend viewable in the application.

18. The method of claim 16, wherein the mobile device comprises at least one of a mobile phone, a mobile tablet, and a computer.
